(19) United States
(12) Patent Application Publication
(10) Pub. No.: US 2003/0173434 A1
(43) Pub. Date: Sep. 18, 2003

(54) Sabretooth Screen/Grate

(76) Inventors: Doug Mickael Poland, Lake Park, FL (US); Patrick Daniel Byers, Royal Palm Beach, FL (US)

Correspondence Address: Doug Mickael Poland, 209 Park Avenue, Lake Park, FL, 33403, US

(21) Appl. No.: 10/359,847

(22) Filed: Feb. 7, 2003

Related U.S. Application Data
(60) Provisional application No. 60/339,273, filed on Feb. 15, 2002.

(51) Int. Cl. B07B 13/00

(52) U.S. Cl. 241/83

(57) ABSTRACT

The invention provides for an alternative to traditional designs of screens or grates utilized in conjunction with Comminutors, Crushers, Grinders, and Shredders, that size reduce various materials including but not limited to Aggregates, Metals, Wood, Construction and Demolition debris, Vegetation Wood Fiber products, Solid Waste, and Plastics.

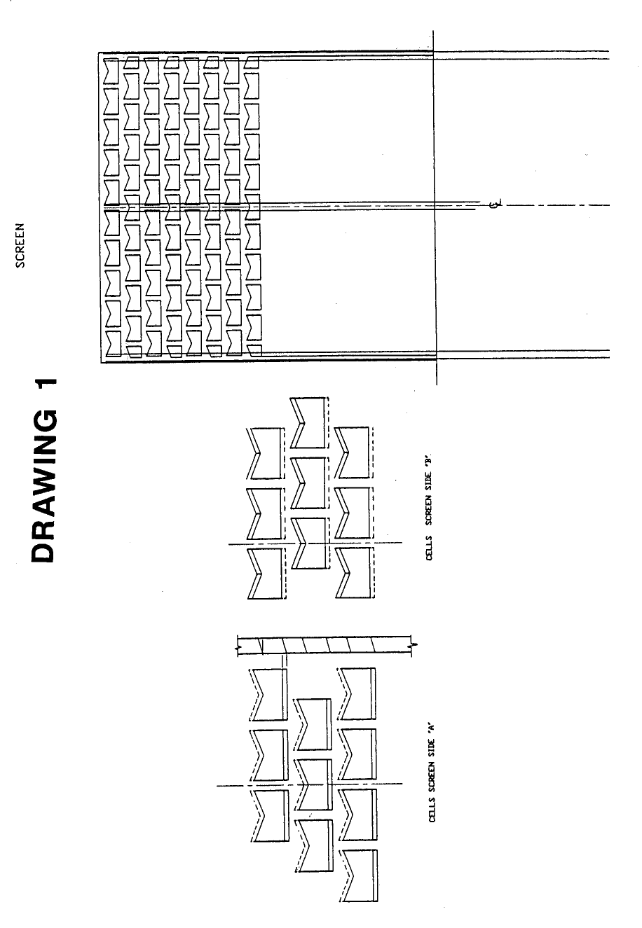

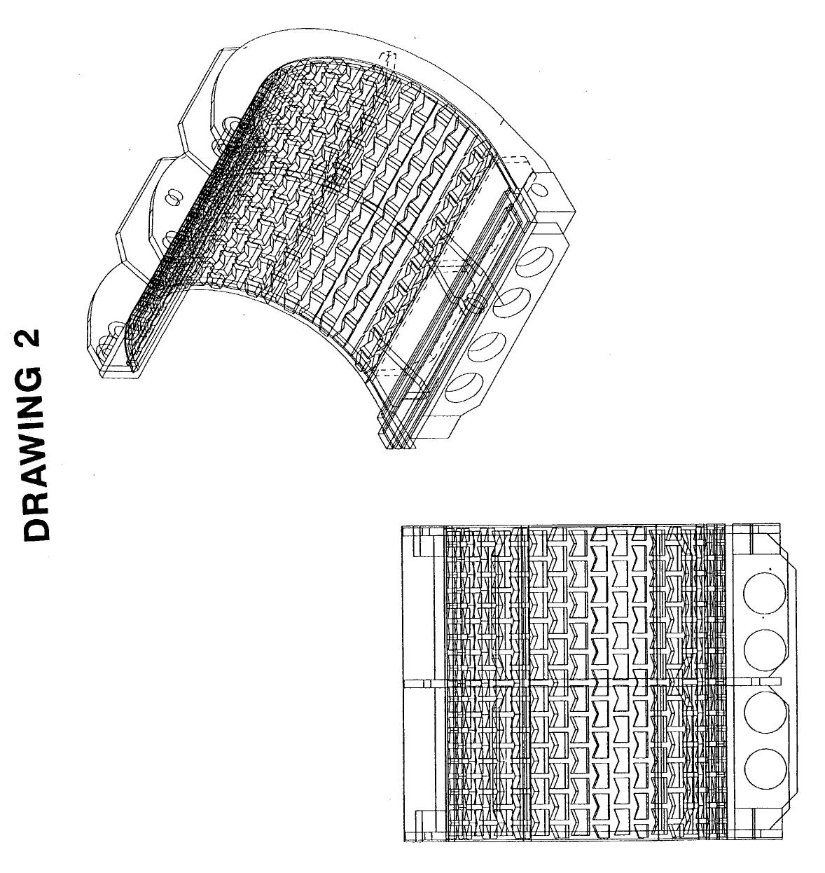

### CROSS REFERENCE TO RELATED APPLICATIONS

Provisional Application No. 60/339,273 filed on Feb. 15, 2002.

### FED SPONSORED R@D

There is no Federal sponsorship.

### BACKGROUND

The submitted design has been utilized in selective operations by the inventors during the past seven years. This was conceived as a uniquely designed opening for use in the communition and/or size reduction of various materials.

### SUMMARY OF THE INVENTION

The Sabretooth Screen/Grate is a uniquely designed screen or grate opening different from those traditionally utilized in communition or size reduction of various materials.

### DESCRIPTION OF DRAWINGS

Drawing #1—References the general shape of the Sabretooth Screen/Grate design. The basic design consists of a triangular tooth that protrudes into a rectangular, square or similar opening. The lack of dimensions references the fact that this design can be of various angles sizes and depths. The drawing also references that the designed triangular tooth can be of a square or bias cut.

Drawing #2—Depicts a three dimensional view of what a typical screen or grate utilizing the Sabretooth design might look like. There are no dimensions referenced in this drawing because of their variability.

### DETAILED DESCRIPTION

The Sabretooth Screen/Grate was designed to more efficiently cut, process and screen materials in a grinding or shredding system that utilizes a rotor and hammer design. Constructed of various metals, thickness, shapes, and sizes to fit an individual system design. The Sabretooth design is unique from conventional designs currently in use. The basic design consists of triangular teeth that protrude into a rectangular, square, or similar screen or grate opening. The Sabretooth itself can be of various angles sizes and depths. The triangular design can be of a square or bias configuration. The design is intended to provide more cutting surface within an opening than traditional methods. The sabretooth Screen/Grate can be designed and manufactured to fit any grinding or shredding system.

What is claimed is:

1. A unique opening in a screen or grate utilized in conjunction with a rotor grinding member which is mounted on a frame for rotation about a horizontal axis.
